(19) United States
(12) Patent Application Publication
(10) Pub. No.: US 2012/0307278 A1
(43) Pub. Date: Dec. 6, 2012

(54) IMAGE PROCESSING APPARATUS, IMAGE PROCESSING CONTROL METHOD, AND A STORAGE MEDIUM STORING A COMPUTER-READABLE PROGRAM OF AN IMAGE PROCESSING APPARATUS FOR INTERRUPTING IMAGE READING

(75) Inventor: Toru Takahashi, Kawasaki-shi (JP)

(73) Assignee: CANON KABUSHIKI KAISHA, Tokyo (JP)

(21) Appl. No.: 13/481,595

(22) Filed: May 25, 2012

(30) Foreign Application Priority Data
May 31, 2011 (JP) 2011-122017

(51) Int. Cl. G06K 15/02

(52) U.S. Cl. 358/1.13

(57) ABSTRACT

An image processing apparatus includes a conveyance unit configured to convey a document placed on a first position to make the document pass a second position, a reading unit configured to read an image at the second position to generate image data, a first determination unit configured to determine whether a document is placed on the first position, a second determination unit configured to determine whether the image data generated by the reading unit satisfies a predetermined condition, and a control unit configured to interrupt reading of the image by the reading unit when the first determination unit determines that the document is placed on the first position and the second determination unit determines that the image data generated by the reading unit satisfies the predetermined condition.

### BACKGROUND OF THE INVENTION

1. Field of the Invention

The present invention relates to an image processing apparatus configured to read an image.

2. Description of the Related Art

Conventionally, an image processing apparatus that reads images in two manners has been developed, as discussed in Japanese Patent Application Laid-Open No. 2003-87453 for example. Such an image processing apparatus includes a conveyance unit called automatic document feeder (ADF) to convey documents, and a document detection sensor which detects whether a document is placed on the ADF.

When the document detection sensor detects no documents on the ADF, the image processing apparatus reads images of a document without use of the ADF. In this case, an image sensor moves below a document positioning plate to read the images of the document placed on the document positioning plate.

When the document detection sensor detects a document, the image processing apparatus uses the ADF to read images of the document. In this case, the image sensor moves to a predetermined reading position where the images of the document conveyed by the ADF are read.

With reference to FIGS. 10A and 10B, the two manners to read a document are described in more detail.

In a first manner, a user places a document as illustrated in FIG. 10A. The user opens a pressing plate 1002 to place the document on a glass plate 1003, and closes the pressing plate 1002. The image processing apparatus reads images of the document while keeping the document at the position on the glass plate 1003. The image processing apparatus moves an optical unit below the glass plate 1003 to read images of the document, and generates image data. Even if the pressing plate 1002 is open, the image processing apparatus can read the images of the document.

In a second manner, a user places a document as illustrated in FIG. 10B. The user places the document on a tray 1006 while the pressing plate 1002 is closed. The image processing apparatus reads images of the document conveyed by an ADF 1001 and a conveyance roller 1005. The image processing apparatus sets an optical unit in place below a slit 1004. The conveyance roller 1005 conveys the document so that the document passes above the optical unit. The image processing apparatus reads the document passing above the optical unit set in place, and generates image data.

When image reading is instructed while the document is placed on the tray 1006 and the pressing plate 1002 is open, the ADF 1001 and the conveyance roller 1005 convey the document, but the document does not pass above the optical unit, resulting in generation of image data different from the one the user has intended.

For example, assume that a user places a document as illustrated in FIG. 10A without knowing the presence of another document placed on the tray 1006, and instructs image reading while the pressing plate 1002 is open. In this case, the image processing apparatus reads images of the document in the second manner, and generates totally black image data. The image data gets black due to the absence of reflected light. Accordingly, a plurality of documents results in a plurality of sheets with the entirely black image data thereon.

### SUMMARY OF THE INVENTION

The present invention is directed to an image processing apparatus capable of interrupting image reading that is different from that a user has intended. For example, while a document is placed on a tray and a pressing plate is open as illustrated in FIG. 10A, the image processing apparatus is capable of interrupting image reading without use of a sensor that detects opening of the pressing plate.

According to an aspect of the present invention, an image processing apparatus includes a conveyance unit configured to convey a document placed on a first position to make the document pass a second position, a reading unit configured to read an image at the second position to generate image data, a first determination unit configured to determine whether a document is placed on the first position, a second determination unit configured to determine whether the image data generated by the reading unit satisfies a predetermined condition, and a control unit configured to interrupt reading of the image by the reading unit when the first determination unit determines that the document is placed on the first position and the second determination unit determines that the image data generated by the reading unit satisfies the predetermined condition.

Further features of the present invention will become apparent from the following description of exemplary embodiments with reference to the attached drawings.

### BRIEF DESCRIPTION OF THE DRAWINGS

The accompanying drawings, which are incorporated in and constitute a part of the specification, illustrate exemplary embodiments, features, and aspects of the invention and, together with the description, serve to explain the principles of the invention.

FIG. 1 illustrates a hardware configuration of an image processing apparatus according to an exemplary embodiment of the present invention.

FIG. 2 is a cross sectional diagram illustrating an image processing apparatus of an exemplary embodiment of the present invention.

FIG. 3 illustrates an exterior of a scanner unit.

FIG. 4 illustrates an exterior of the scanner unit.

FIG. 5 illustrates a configuration of a control program incorporated in an image processing apparatus.

FIG. 6 is a flowchart illustrating scan processing.

FIG. 7 is a flowchart illustrating determination processing.

FIG. 8 is a flowchart illustrating scan processing.

FIG. 9 is a flowchart illustrating scan processing.

FIGS. 10A and 10B illustrate two manners respectively to read a document.

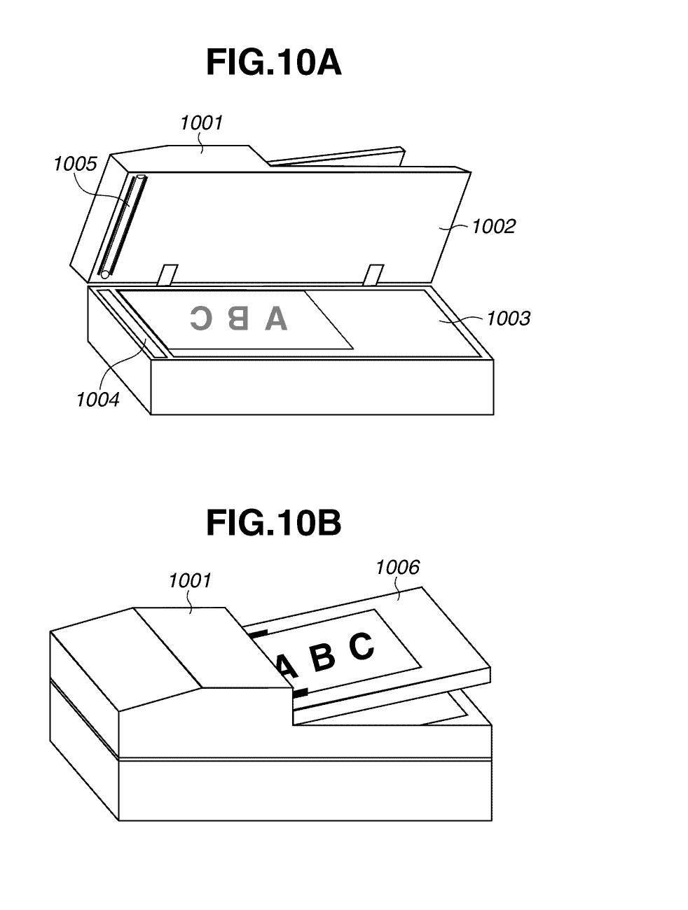

### DESCRIPTION OF THE EMBODIMENTS

Various exemplary embodiments, features, and aspects of the invention will be described in detail below with reference to the drawings.

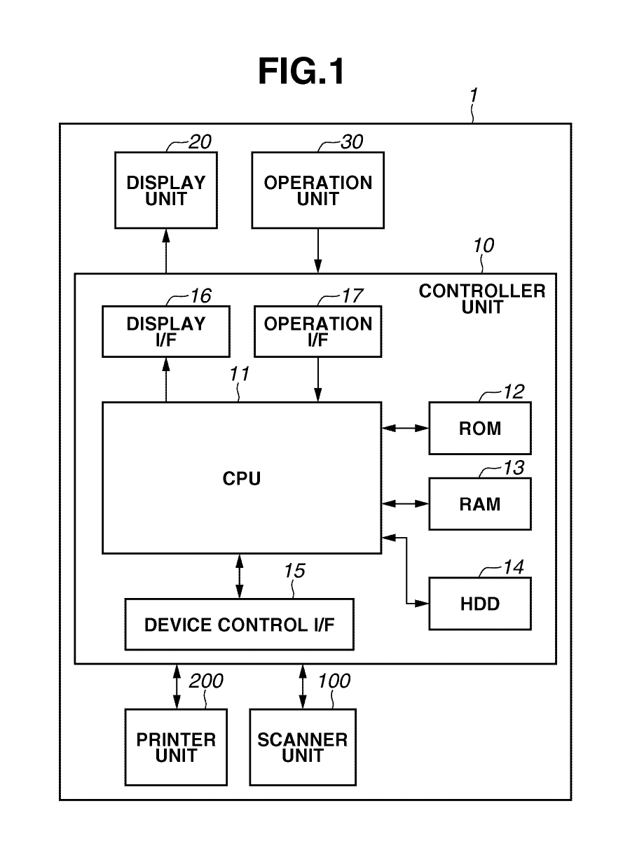

FIG. 1 illustrates a hardware configuration of an image processing apparatus according to an exemplary embodiment of the present invention. An image processing apparatus 1 includes a controller unit 10, a display unit 20, an operation unit 30, a scanner unit 100, and a printer unit 200.

The controller unit 10 includes a central processing unit (CPU) 11, a read only memory (ROM) 12, a random access memory (RAM) 13, a hard disk drive (HDD) 14, a device control interface (I/F) 15, a display I/F 16, and an operation I/F 17.

The CPU 11 is the main component to execute control programs stored in the image processing apparatus 1, and controls various devices in the image processing apparatus 1.

The ROM 12 is a non-volatile memory. The RAM 13 is a volatile memory. The HDD 14 is a magnetic disk.

The control programs are stored in the ROM 12 or the HDD 14, and are each loaded from the ROM 12 or the HDD 14 to the RAM 13 to be executed. The RAM 13 functions as a work memory while the CPU 11 is executing one or more of the control programs, and stores print jobs and image data. The HDD 14 also stores print jobs and image data. The ROM 12, the RAM 13, and the HDD 14 each function as a storage unit to store data or programs.

FIG. 1 illustrates only one CPU 11, one ROM 12, one RAM 13, and one HDD 14. However, a plurality of CPUs 11, ROMs 12, RAMs 13, and HDDs 14 may be incorporated in the image processing apparatus 1.

The device control I/F 15 controls input/output to and from devices (e.g., the scanner unit 100 and the printer unit 200) connected to the controller unit 10 to transmit control instructions to the devices and receive status information from the devices. The device control unit I/F 15 has a bus structure connectable to a plurality of devices. Alternatively, the device control I/F 15 may be divided into a plurality of interfaces, so that the plurality of devices can be associated with the plurality of interfaces respectively.

The display I/F 16 controls output to the display unit 20. The operation I/F 17 controls input from the operation unit 30.

The display unit 20 includes a light emitting diode (LED) and a liquid crystal display to display operation contents from an operator and internal states of the image processing apparatus 1. The operation unit 30 accepts operations and instructions from an operator. The operation unit 30 has a plurality of operation buttons. The display unit 20 and the operation unit 30 may be provided as a touch panel display.

The scanner unit 100 performs driving control of a conveyance roller and control of an optical unit incorporated in the image processing apparatus 1 to read images of a document and generate image data. The printer unit 200 performs driving control of roller units, control of image transfer, and control of image fixing, to print image data onto a recording medium.

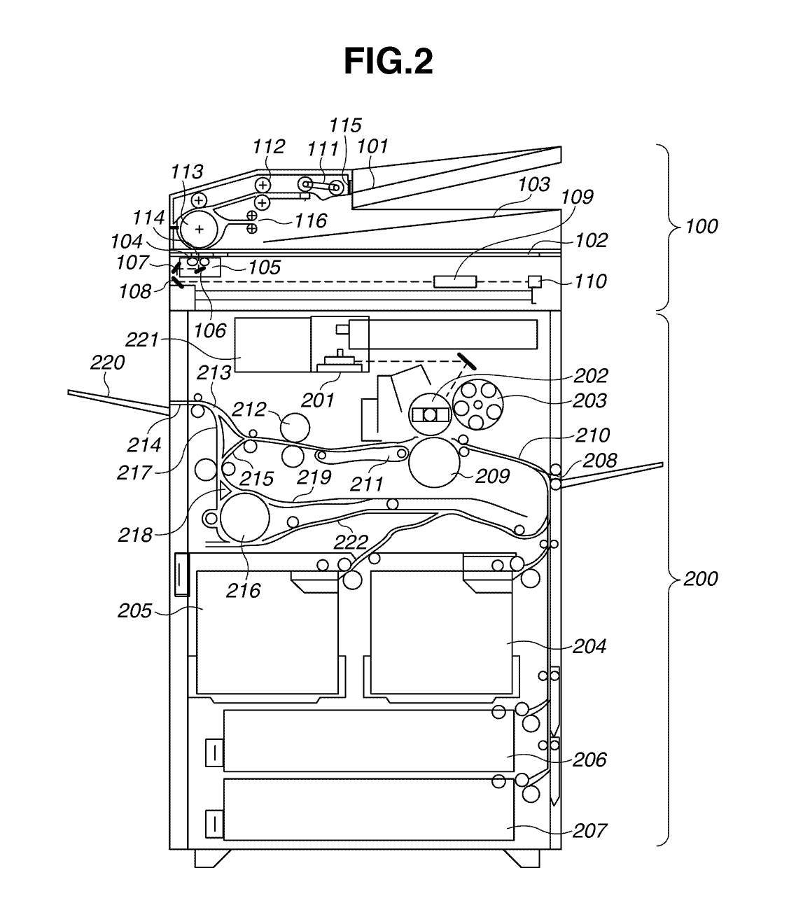

FIG. 2 is a cross sectional diagram illustrating the image processing apparatus 1 according to an exemplary embodiment of the present invention.

The scanner unit 100 is described. When the scanner unit 100 reads the document placed on the document feeding tray 101, an optical unit 105 is set in place below a slit 114, and a lamp 104 is turned on. In this situation, sheets of the document on the document feeding tray 101 are conveyed serially one by one. As the document moves relative to the optical unit 105, the optical unit 105 exposes the document.

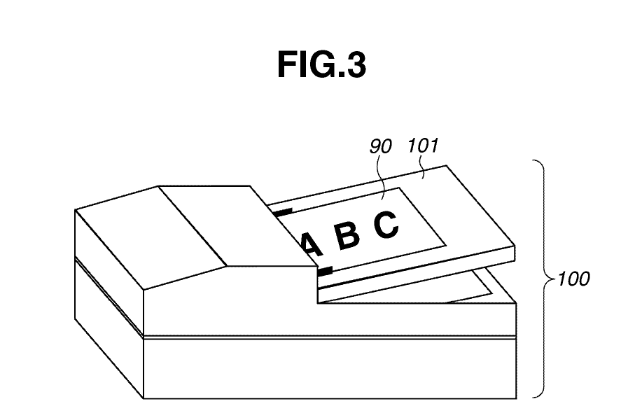

As illustrated in FIG. 3, a user sets a document on the document feeding tray 101. A sensor 115 then detects that the document is placed on the document feeding tray 101. As being pulled in by a pickup roller 111, the document passes through a first conveyance roller 112, and a second conveyance roller 113, and passes over the optical unit 105, to be discharged to a discharge tray 103. In other words, the pickup roller 111, the first and the second conveyance rollers 112 and 113 convey the document placed at a position corresponding to the document feeding tray 101 to pass it to a position above the optical unit 105.

When the scanner unit 100 reads both sides of the document, a reversing roller 116 inverts the document that has passed over the optical unit 105, to reverse the document upside down. Then, the document again passes through the second conveyance roller 113 and moves over the optical unit 105. During the moving, the optical unit 105 exposes the reverse side of the document. Subsequently, the reversing roller 116 again inverts the document to discharge it to the discharge tray 103.

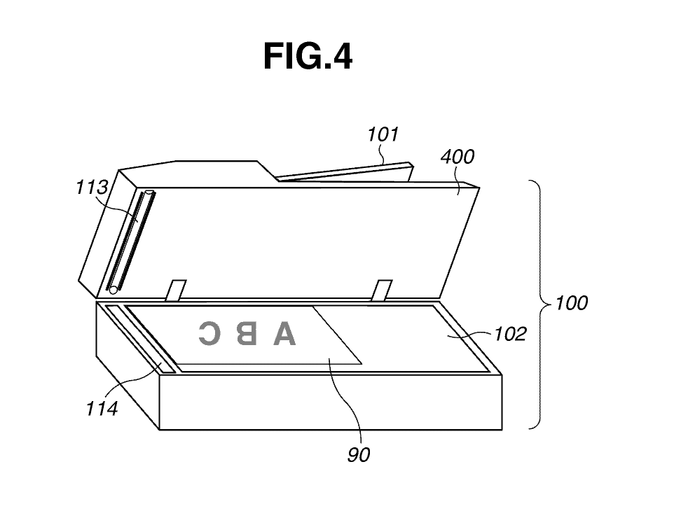

When the scanner unit 100 reads a document placed on the platen glass 102, the lamp 104 is turned on, and the optical unit 105 moves while exposing the document. In other words, the optical unit 105 performs exposure during scanning. The scanner unit 100 includes a pressing plate 400 (FIG. 4) to fix a document placed on the platen glass 102. As illustrated in FIG. 4, the pressing plate 400 is openable and closable, so that a user can open the pressing plate 400 to set a document on the platen glass 102.

The reflected light from the exposed document is led by a mirror 106, a mirror 107, a mirror 108, and a lens 109 to a charge coupled device (CCD) image sensor 110. As a result, the images of the document are captured by the CCD image sensor 110. The CCD image sensor 110 outputs image data, which is subjected to predetermined processing to be transferred to the controller unit 10. The controller unit 10 is described in detail with reference to FIG. 4.

The printer unit 200 is described. A laser driver 221 drives a laser emitting unit 201. The laser driver 221 controls the laser emitting unit 201 to emit a laser beam corresponding to the image data output from the controller unit 10. The emitted laser beam illuminates a photosensitive drum 202 to form a latent image corresponding to the laser beam onto the photosensitive drum 202. To a portion having the latent image on the photosensitive drum 202, a developer is adhered by a development unit 203.

The printer unit 200 includes cassettes 204, 205, 206 and 207, and a manual paper feeding stage 208. The cassettes 204 to 207 each have a shape like a drawer. The manual paper feeding stage 208 is used to feed sheets of paper from a tray exposed to outside of the apparatus 1. The user supplies sheets of paper by pulling one of the cassettes 204 to 207, and then closes the cassette.

At the timing in synchronization with the start of illumination of a laser beam, a sheet of paper is fed from one of the cassettes 204 to 207 or the manual paper feeding stage 208. The sheet passes a conveyance path 210 to a transfer unit 209. The transfer unit 209 transfers the developer on the photosensitive drum 202 to the sheet.

The sheet having the developer thereon is conveyed to a fixing unit 212 by a conveyance belt 211. The fixing unit 212 uses heat and pressure to fix the developer onto the sheet. The sheet then passes conveyance paths 213 and 214 to be discharged to a sheet discharge bin 220. In the case where the sheet is to be reversed before the discharge, the sheet is led by a conveyance path 215 to a conveyance path 216 where the sheet is reversed upside down. Subsequently the sheet passes a conveyance path 217 and the conveyance path 214 to be discharged to the sheet discharge bin 220.

When the printer unit 200 performs printing on both sides of a sheet, the sheet, after passing the fixing unit 212, passes the conveyance path 215, and is led by a flapper 218 to a conveyance path 219. The sheet is then conveyed in the opposite direction along the conveyance path 219. Subsequently, the sheet passes the flapper 218, the conveyance path 216, a conveyance path 222, and the conveyance path 210 to the transfer unit 209.

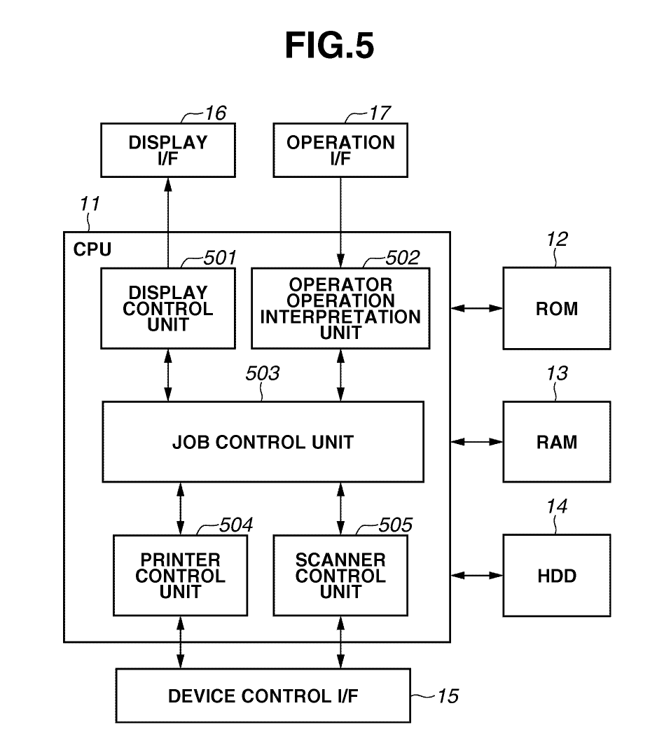

FIG. 5 illustrates a configuration of a control program incorporated in the image processing apparatus 1.

The control programs are stored in one of the ROM 12, the RAM 13, and the HDD 14, and are executed by the CPU 11. Executions of the control programs by the CPU 11 respectively implement a display control unit 501, an operator operation interpretation unit 502, a job control unit 503, a printer control unit 504, and a scanner control unit 505.

The display control unit 501 receives a job status and status information indicating a state of the image processing apparatus 1 from the job control unit 503, and transmits a command to the display I/F 16 to display the information on the display unit 20.

The operator operation interpretation unit 502 receives an operation command from the operation I/F 17, interprets it to transmit an instruction such as start, stop, resume, end of a job for example, depending on the interpretation.

When receiving an instruction to start a job from the operator operation interpretation unit 502, the job control unit 503 issues an instruction to the printer control unit 504 or the scanner control unit 505 depending on the job type, to start the job. When receiving an instruction to stop, resume, or end a job from the operator operation interpretation unit 502, the job control unit 503 issues an instruction to the printer control unit 504 or the scanner control unit 505 to control execution of the job.

The job control unit 503 also interrupts execution of a job, reading of a document using the scanner control unit 505, and printing using the printer control unit 504, according to the flowcharts described below.

Furthermore, the job control unit 503 uses the display control unit 501 to display a job status, a state of the image processing apparatus 1, and a warning on the display unit 20.

The printer control unit 504 controls the printer unit 200 through the device control I/F 15 so that image data can be printed on a recording medium. The scanner control unit 505 controls the canner unit 100 through the device control I/F 15 so that a document can be read in as image data.

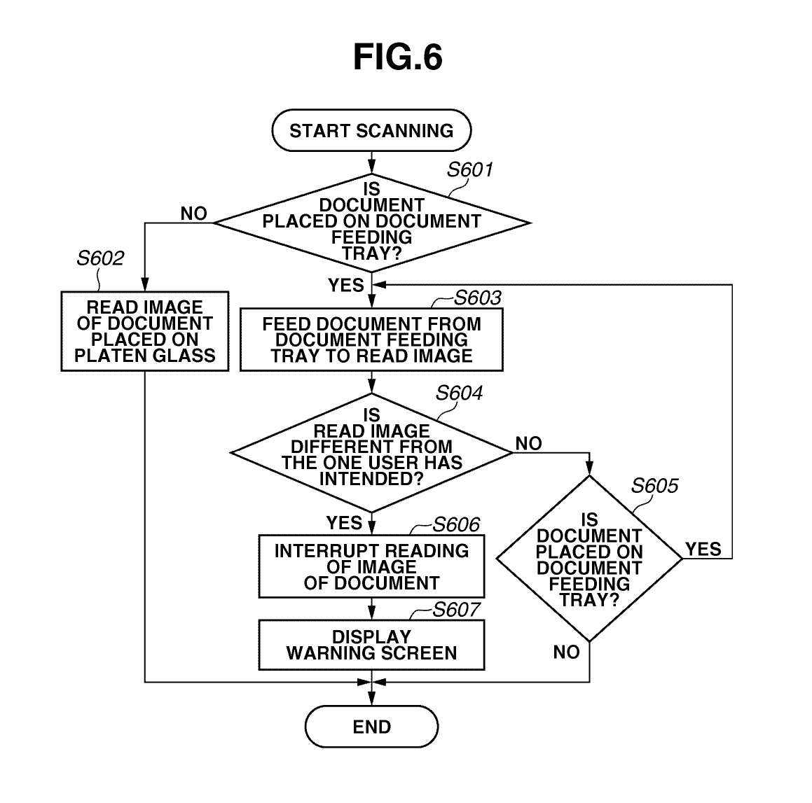

FIG. 6 is a flowchart illustrating an image processing control method according to an exemplary embodiment of the present invention. The scanning processing is performed when the CPU 11 executes a corresponding control program.

When the operator operation interpretation unit 502 receives, through the operation unit 30, an instruction to start a job from a user, the job control unit 503 starts the scanning processing.

In step S601, the scanner control unit 505 uses the sensor 115 to determine whether a document is placed on the document feeding tray 101. When no document is placed (NO in step S601), in step S602, the scanner control unit 505 controls the scanner unit 100 to read an image of a document placed on the platen glass 102.

When a document is placed on the document feeding tray 101 (YES in step S601), in step S603, the scanner control unit 505 controls the scanner unit 100 so that the document placed on the document feeding tray 101 can be fed and an image thereof can be read.

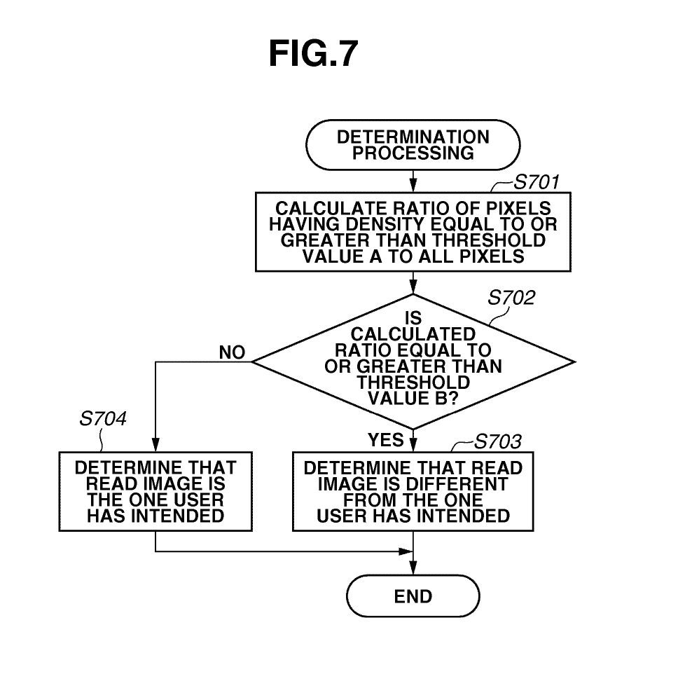

In step S604, the job control unit 503 receives image data of the image read in step S603, through the scanner control unit 505, and determines whether the image is different from the one the user has intended. The job control unit 503 makes the determination by determining whether the image satisfies a predetermined condition. The determination processing will be described with reference to FIG. 7.

When the job control unit 503 determines that the image is not different from the one the user has intended (NO in step S604), in step S605, the scanner control unit 505 uses the sensor 115 to determine whether another document is placed on the document feeding tray 101. When no document is placed on the document feeding tray 101 (NO in step S605), reading of an image of a document ends. When another document is placed on the document feeding tray 101 (YES in step S605), the processing returns to step S603 to continue to read the image of the document.

When the job control unit 503 determines that the image is different from the one the user has intended (YES in step S604), in step S606, the job control unit 503 transmits an instruction to the scanner control unit 505 to interrupt reading of the image. The scanner control unit 505, according to the instruction, causes the scanner unit 100 to interrupt reading of the image of the document.

In step S607, the job control unit 503 instructs the display control unit 501 to display a warning. The display control unit 501, according to the instruction, controls the display unit 20 to display a message indicating that reading of the image of the document on the document feeding tray 101 was interrupted. Alternatively, the display control unit 501 controls the display unit 20 to display a message indicating that a document remains left on the document feeding tray 101.

After interrupting image reading in step S606, the job control unit 503 may store the image data of the image already read into the HDD 14 as it is. Alternatively, the job control unit 503 may delete the image data of the read image. The latter case can save storage capacity of the HDD 14.

The job control unit 503 may make the determination in step S604 based on image data for one page, or based on image data for less than one page. In the case where the job control unit 503 makes the determination in step S604 after receiving image data for one page, no images of subsequent sheets will be read. On the other hand, in the case where the job control unit 503 makes the determination in step S604 after receiving image data a predetermined amount less than that of one page, reading of the image of the current sheet can be interrupted in the middle of the page.

The image processing apparatus 1 interrupts reading of an image when the image is determined to be different from the one a user has intended, which prevents subsequent reading of images the user does not intend.

The interruption of image reading refers to both of completely ending of reading of an image in the middle of the image and temporarily stopping of reading of the image.

FIG. 7 is a flowchart illustrating the determination processing in step S604. The determination processing is also performed when the CPU 11 executes a corresponding control program.

In step S701, the job control unit 503 analyzes image data received through the scanner control unit 505, and calculates a ratio of pixels having a density equal to or greater than a threshold value A to all the pixels in the image data. The threshold value A is stored in advance in one of the ROM 12, the RAM 13, and the HDD 14.

In step S702, the job control unit 503 determines whether the ratio calculated in step S701 is equal to or greater than a threshold value B. The threshold value B is also stored in advance in one of the ROM 12, the RAM 13, and the HDD 14.

When the ratio is equal to or greater than the threshold value B (YES in step S702), in step S703, the job control unit 503 determines that the read image is different from the one the user has intended. In other words, the job control unit 503 determines that the image was read while the pressing plate 400 is open. When an image is read while the pressing plate 400 is open, the reading results in entirely black image data, and the black image data has the number of pixels greater than a predetermined value, the pixels having a density equal to or greater than a predetermined value.

When the ratio is less than the threshold value B (NO in step S702), in step S704, the job control unit 503 determines that the read image is the one the user has intended. In other words, the job control unit 503 determines that the image was read while the pressing plate 400 is closed.

The processing in FIG. 7 enables the image processing apparatus to determine whether the pressing plate 400 is open or closed without a sensor for detecting opening/closing of the pressing plate 400.

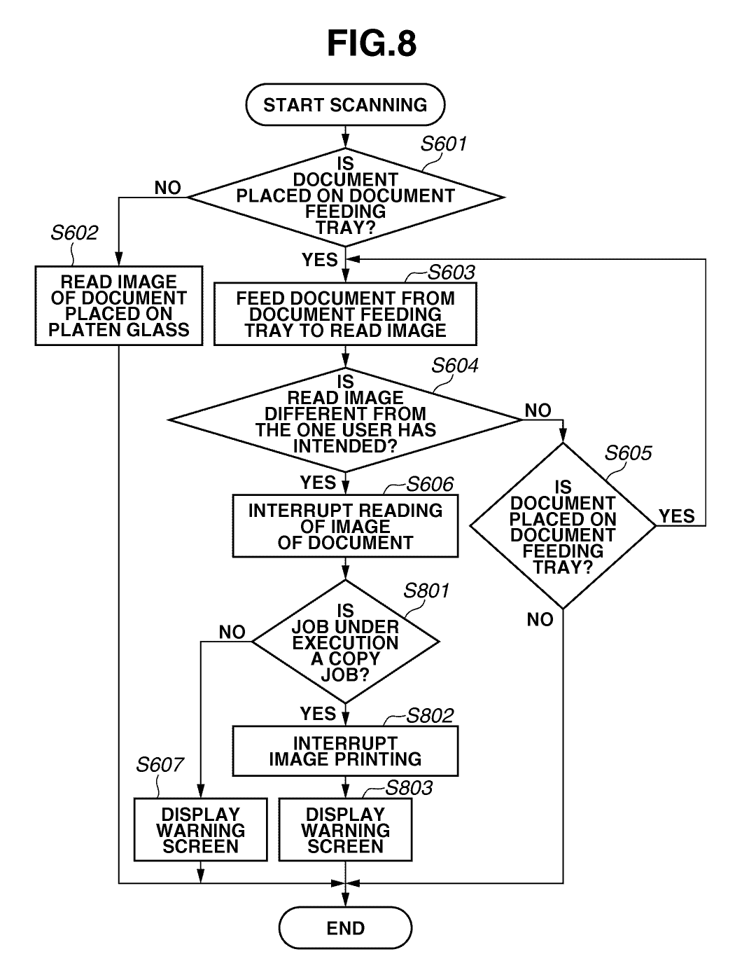

FIG. 8 illustrates a flowchart of a modification (the second exemplary embodiment) of the one illustrated in FIG. 6. In FIG. 8, the same steps as those in FIG. 6 have the same reference numerals as those in FIG. 6.

In step S801 in FIG. 8, after interrupting reading of the image of the document, the job control unit 503 determines whether the job under execution is a copy job. When the job under execution is a copy job (YES in step S801), in step S802, the job control unit 503 transmits an instruction to interrupt printing to the printer control unit 504. The printer control unit 504 causes the printer unit 200 to interrupt printing of the image data according to the instruction. The interruption prevents unnecessary printing and avoids printing of entirely black images.

In step S803, the job control unit 503 issues an instruction to the display control unit 501 to display a warning. According to the instruction to display a warning, the display control unit 501 controls the display unit 20 to display a message indicating that copying of the document placed on the document feeding tray 101 was interrupted.

When the job under execution is not a copy job but a scan job, only display of a warning is performed because any image has not been printed at all. The job control unit 503 issues an instruction to the display control unit 501 to display a warning, and in step S607, the display control unit 501 displays a message indicating that reading of the image of the document placed on the document feeding tray 101 was interrupted.

Through the processing, image reading can be interrupted when a document is placed on the document feeding tray 101 and reading of an image of the document is started while the pressing plate 400 is open. Especially even if the apparatus 1 does not have a mechanism to detect opening of the pressing plate 400, the processing enables interruption of reading of an image that a user does not intend.

In the image processing control method in FIG. 6, an image is read after a document having the image is fed, and the read image is determined as to whether it satisfies a predetermined condition. The image, however, may be read and the read image can be determined as to whether it satisfies a predetermined condition, before the document having the image is fed.

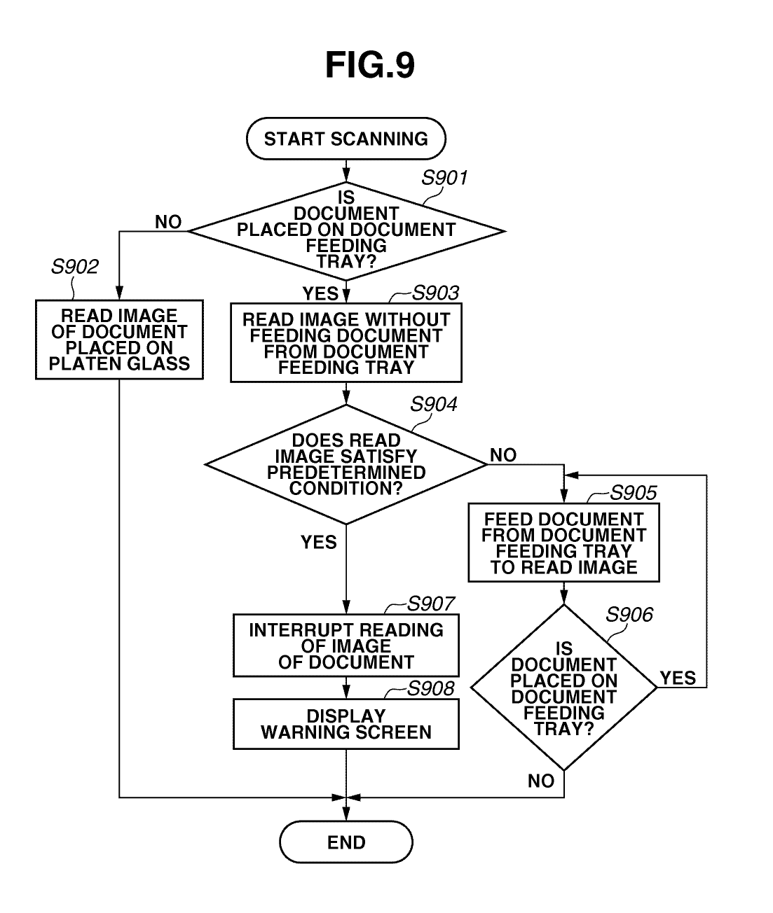

FIG. 9 is a flowchart illustrating an image processing control method according to a third exemplary embodiment. The scan processing is performed when the CPU 11 executes a corresponding control program.

When the operator operation interpretation unit 502 receives, through the operation unit 30, an instruction to start a job from a user, the job control unit 503 starts the scanning processing.

In step S901, the scanner control unit 505 uses the sensor 115 to determine whether a document is placed on the document feeding tray 101. When no document is placed on the document feeding tray 101 (NO in step S901), in step S902, the scanner control unit 505 controls the scanner unit 100 to read an image of the document placed on the platen glass 102.

When a document is placed on the document feeding tray 101 (YES in step S901), in step S903, the scanner control unit 505 controls the scanner unit 100 to read an image without feeding the document.

In step S904, the job control unit 503 receives image data of the image read in step S903, through the scanner control unit 505, and determines whether the read image satisfies a predetermined condition. The determination processing has been described with reference to FIG. 7. Even if the document is not fed from the document feeding tray 101, the closed pressing plate 400 prevents generation of entirely black read image. This is because the light reflected by, for example, the second conveyance roller 113 is read by the CCD image sensor 110. In contrast, the open pressing plate 400 results in generation of entirely black read image.

In step S905, when the read image does not satisfy the predetermined condition (NO in step S904), the scanner control unit 505 controls the scanner unit 100 to feed the document placed on the document feeding tray 101 to read an image of the document.

In step S906, the scanner control unit 505 uses the sensor 115 to determine whether another document is placed on the document feeding tray 101. When no more document is placed on the document feeding tray 101 (NO in step S906), reading of an image of a document ends. When another document is placed on the document feeding tray 101 (YES in step S906), the processing returns to step S905 to continue to read an image of the document.

When the read image satisfies the predetermined condition (YES in step S904), in step S907, the job control unit 503 transmits an interruption instruction to the scanner control unit 505. The scanner control unit 505 causes the scanner unit 100 to interrupt reading of the image of the document, according to the interruption instruction. The interruption in this case refers to no start of feeding of a document at all.

In step S908, the job control unit 503 issues an instruction to the display control unit 501 to display a warning. The display control unit 501 controls the display unit 20 to display a message indicating that reading of the image of the document on the document feeding tray 101 was interrupted, according to the instruction to display a warning. Alternatively, the display control unit 501 controls the display unit 20 to display a message indicating that a document remains left on the document feeding tray 101.

In the third exemplary embodiment, the step S903 can be performed while the pressing plate 400 is closed, but when the pressing plate 400 is open, the image reading can be interrupted without feeding of a document.

According to the exemplary embodiments of the present invention, the image processing apparatus can prevent reading of images a user has not intended.

Aspects of the present invention can also be realized by a computer of a system or apparatus (or devices such as a CPU or MPU) that reads out and executes a program recorded on a memory device (computer-readable medium) to perform the functions of the above-described embodiments, and by a method, the steps of which are performed by a computer of a system or apparatus by, for example, reading out and executing a program recorded on a memory device to perform the functions of the above-described embodiments. For this purpose, the program is provided to the computer for example via a network or from a recording medium of various types serving as the memory device (e.g., computer-readable medium). In such a case, the system or apparatus, and the recording medium where the program is stored, are included as being within the scope of the present invention.

While the present invention has been described with reference to exemplary embodiments, it is to be understood that the invention is not limited to the disclosed exemplary embodiments. The scope of the following claims is to be accorded the broadest interpretation so as to encompass all modifications, equivalent structures, and functions.

This application claims priority from Japanese Patent Application No. 2011-122017 filed May 31, 2011, which is hereby incorporated by reference herein in its entirety.

What is claimed is:

1. An image processing apparatus, comprising:
a conveyance unit configured to convey a document placed on a first position to make the document pass a second position;
a reading unit configured to read an image at the second position to generate image data;
a first determination unit configured to determine whether a document is placed on the first position;
a second determination unit configured to determine whether the image data generated by the reading unit satisfies a predetermined condition; and
a control unit configured to interrupt reading of the image by the reading unit when the first determination unit determines that the document is placed on the first position and the second determination unit determines that the image data generated by the reading unit satisfies the predetermined condition.

2. The image processing apparatus according to claim 1, wherein the predetermined condition is a condition to identify an image different from an image a user has intended.

3. The image processing apparatus according to claim 1, wherein the predetermined condition specifies that a ratio of pixels having a density equal to or greater than a first threshold value to all the pixels of the image data is equal to or greater than a second threshold value.

4. The image processing apparatus according to claim 1, further comprising a display unit configured to display a message indicating an interruption of image reading.

5. The image processing apparatus according to claim 1, wherein the reading unit reads an image of a next document, when the first determination unit determines that the document is placed on the first position and the second determination unit determines that the image data generated by the reading unit does not satisfy the predetermined condition.

6. The image processing apparatus according to claim 1, further comprising a printing unit configured to print an image based on the image data generated by the reading unit, wherein the control unit interrupts printing of the image performed by the printing unit when the first determination unit determines that the document is placed on the first position and the second determination unit determines that the image data generated by the reading unit satisfies the predetermined condition.

7. The image processing apparatus according to claim 1, wherein the reading unit reads the image at the second position before the conveyance unit conveys the document to the second position, and
wherein the second determination unit determines whether the image data generated by the reading unit satisfies the predetermined condition before the conveyance unit conveys the document to the second position.

8. An image processing control method executed by an image processing apparatus, the method comprising:
conveying a document placed on a first position to make the document pass a second position;
reading an image at the second position to generate image data;
determining whether a document is placed on the first position;
determining whether the generated image data satisfies a predetermined condition; and
interrupting reading of the image when the document is determined to be placed on the first position and the generated image data is determined to satisfy the predetermined condition.

9. A storage medium storing a computer-readable program of an image processing apparatus comprising a conveyance unit configured to convey a document placed on a first position to make the document pass a second position and a reading unit configured to read an image at the second position to generate image data, the program causing a computer to execute:
determining whether a document is placed on the first position;
determining whether the image data generated by the reading unit satisfies a predetermined condition; and
interrupting reading of the image by the reading unit when the document is determined to be placed on the first position and the generated image data is determined to satisfy the predetermined condition.
